(19) United States
(12) Patent Application Publication
(10) Pub. No.: US 2019/0197338 A1
(43) Pub. Date: Jun. 27, 2019

(54) Method and System For Automatic and/or Manual Alteration of Obscenity, Indecency or Profanity in images, Videos and Audios to be Uploaded in Social Network

(71) Applicants: Arisa Goto, Redondo Beach, CA (US); Mitsuo Goto, Redondo Beach, CA (US)

(72) Inventors: Arisa Goto, Redondo Beach, CA (US); Mitsuo Goto, Redondo Beach, CA (US)

(21) Appl. No.: 16/197,188

(22) Filed: Nov. 20, 2018

Related U.S. Application Data
(60) Provisional application No. 62/589,088, filed on Nov. 21, 2017.

(51) Int. Cl. G06K 9/46; G06Q 50/00; G06F 16/45; G06F 16/44

(52) U.S. Cl. CPC G06K 9/46; G06F 16/44; G06F 16/45; G06Q 50/01

(57) ABSTRACT

Methods and systems for allowing a user of social network to automatically and/or manually alter contents including obscenity or indecency or profanity, in prior to its uploading procedure to a social network, by in response to automatic detection and automatic alteration of a content, provided methods and systems allow a social network user to create an original versions of alteration by modifying a default version created by an automatic system.

### TECHNICAL FIELD

Certain embodiments of the present disclosure generally relate to data processing and, more particularly, to the method and system provided for users of social network to alter contents including obscenity or indecency or profanity in prior to its uploading procedure to a social network.

### BACKGROUND

Sharing photos and videos are becoming increasingly popular in Social network while checking information in social media has become part of daily routine for many of us. Although most social media platforms apply measures to protect users from offensive speech and abusive behavior, over the course of years, they have raised unprecedented questions and controversies with balancing policy enforcements and with users' right to free speech and free expression.

Inconsistency in methods of deciding what content was allowable by social network service providers makes it more confusing to many users. This is because, most social media platforms apply a process of report, where a user repots a content offensive or abusive, then it is reviewed whether it violates community standards or not, then if it is determined that it does violate standards of Social Network, then the content would be removed from the social network. It has left us with cases that when there has not been any report, an offensive speech and/or abusive behavior had stay in a social network for significant period of time, being shared and going viral in the social network. In the other hand, there has been a case that an opinion of social activist's comment had been deleted immediately due to utterance of profane language.

More serious problem may arise due to inconsistent enforcement of the policy by social networking service providers. When the policy is not clear and enforcements are not consistent, inequality in treatment for protecting against offensive or abusive content depending on a user or a group of users and, at the same time, unfair protection of people's right to free speech and free expression depending on a user or a group of a user may become a custom practice in a network of people.

Often time, methods taken to enforce the policy cause problems as well. Under a policy that is not clear and enforcements that are not consistent, removing content, and suspending or removing account, again raise questions of fairness against a person or a group of people that might be affected.

There should be a tool provided for a user of social network that wishes to upload a content, to alter the content, if including obscenity or indecency or profanity in prior to its uploading procedure to a social network, in the way that will not interference with social network user's freedom of speech. A user of social network should also given an opportunity to alter other undesired information that may have been recorded in its content, such as personal information including, phone numbers, license numbers, etc. in prior to its uploading procedure to a social network.

Unfortunately, in conventional systems, there are not any tools as such given to a user of social network.

### SUMMARY OF THE DISCLOSURE

Certain embodiments provide a system that allows a social network user to automatically and/or manually alter an obscene, indecent or profane content of image, audio or video, in prior to uploading it on a social network. For some embodiments, the system may also alter other kinds of undesired contents such as personal information, personal phone number, license number, etc.

Certain embodiments provide a method generally including automatically and/or manually altering visual data of still image and or video that include content of obscenity or indecency or profanity.

Certain embodiments provide a method generally including automatically and/or manually altering audio data of audio track or video that include obscenity or indecency or profanity.

Certain embodiments provide a gateway for communicating with a content detection component and a content alteration component that support the system to generate an automatically and/or manually alter image, video or audio that has been detected with obscene, indecent or profane contents. The gateway generally includes an interface for communicating with a user of a social network, allowing it to alert user that obscenity or indecency or profanity has been detected in content sent. The gateway may also include an interface providing an opportunity for a user to access a system to generate an automatically and/or manually altered image, audio or video. For some embodiments, the interface may also serve to process further communications in prior to a content being uploaded to a social network.

Certain embodiments provide a content detection component with an object detection engine containing a program for detecting obscenity or indecency or profanity within visual data of an image or a video. When executed by a processor, the program performs operations generally including screening and analyzing visual data and, in response to detecting an obscenity or indecency or profanity, notifying an alert generator of the detected obscenity or indecency or profanity.

Certain embodiments provide a content detection component with an audio detection engine containing a program for detecting obscenity or indecency or profanity within audio data of a soundtrack or a soundtrack of a video. When executed by a processor, the program performs operations generally including screening and analyzing audio data and, in response to detecting an obscenity or indecency or profanity, notifying an alert generator of the detected obscenity or indecency or profanity.

Certain embodiments provide a content detection component with an interface to access digital Database 140 in order to support analytics and training machine learning and deep learning models.

Certain embodiments provide a content alteration component with an image alteration system containing a program for generating altered image, censoring obscenity or indecency or profanity in the content. When executed by a processor, the program performs operations generally including concealing a selected area by distorting using methods such as blurring or apply mosaic, or cover the selected area with solid color or other graphic so the content is unrecognizable. The alteration may be performed automatically without user operation, or also, may be manually operated by a user of social network.

Certain embodiments provide a content alteration component with an audio alteration system containing a program for generating altered audio, censoring obscenity or indecency or profanity in a content. When executed by a processor, the program performs operations generally including concealing a selected time by reducing the volume to inaudible level or deleting from the audio data. Operations may include adding white noise or other sound effect to fill the area of time that had been treated. The alteration may be performed automatically without user operation, or also, may be manually operated by a user of social network.

Certain embodiments provide a content alteration component with a video alteration system containing a program for generating altered video, censoring obscenity or indecency or profanity in a content. When executed by a processor, the program performs operations generally including, for visual corrections, concealing a selected area by distorting using methods such as blurring or apply mosaic, or cover the selected area with solid color or other graphic so the content is unrecognizable, also for audio corrections, concealing a selected time by reducing the volume to inaudible level or deleting from the audio data, then an operation may be followed by a procedure of adding white noise or other sound effect to fill the treated area. The alteration may be performed automatically without user operation, or also, may be manually operated by a user of social network.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an example online communication system, in accordance with certain embodiments of the present disclosure.

FIG. 2 illustrates an example structure that enables to operate a system to alter contents including obscenity, indecency and profanity, in accordance with embodiments of the present disclosure.

FIG. 3 illustrates an example operation of process to operate a system to alter OIP (obscenity, indecency, and profanity), in accordance with certain embodiments of the present disclosure.

FIG. 4 illustrates an example method of an image alteration process, in accordance with embodiments of the present disclosure.

FIG. 5 illustrates an example method of an audio alteration process, in accordance with embodiments of the present disclosure.

FIG. 6 illustrates an example method of a video alteration process, in accordance with embodiments of the present disclosure.

FIG. 7 illustrates an example screen interface for operating an image alteration, in accordance with certain embodiments of the present disclosure.

FIG. 8 illustrates an example screen interface for operating an audio alteration, in accordance with certain embodiments of the present disclosure.

FIG. 9 illustrates an example screen interface for operating a video alteration, in accordance with certain embodiments of the present disclosure.

### DETAILED DESCRIPTION

Embodiments of the present disclosure provide a system for user of social network to operate, in order to automatically and/or manually generate an alteration of image, video or audio including obscene, indecent and profane element or elements, in prior to uploading it on a social network. For some embodiments, the system may also alter other kinds of undesired contents such as personal information, personal phone number, license number, etc.

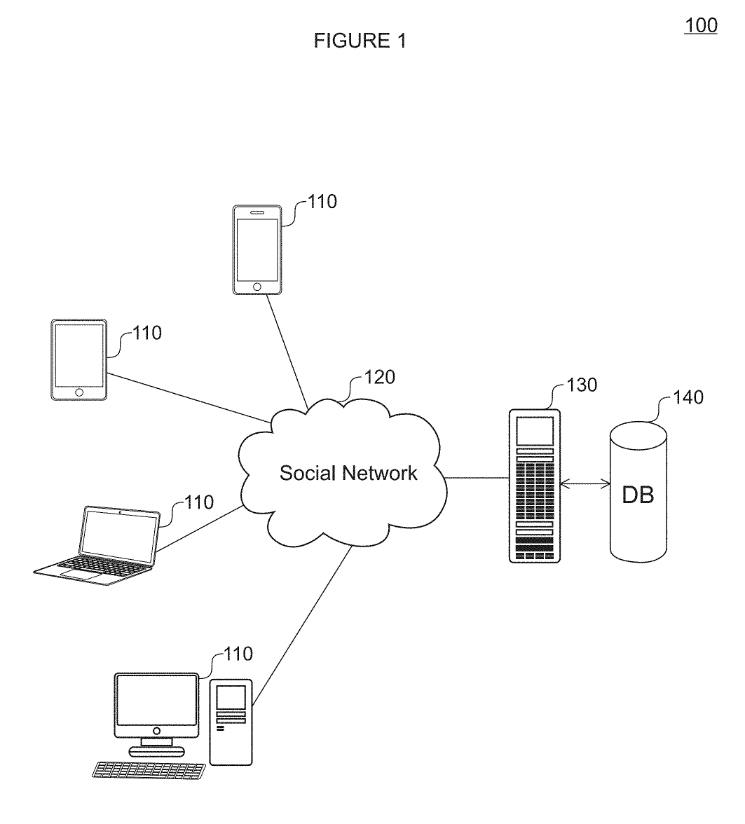

FIG. 1 illustrates an example of environment 100 in which embodiments of the present disclosure may be employed.

FIG. 1 depicts a social network 120, consists of a plurality of users 110 and a social networking service 130. User computers 110 may be fixed or mobile including: smart phones, tablet computers, laptop computers and desktop computers. For some embodiments a social networking service 130 may utilize Database140.

A social network 120 is a network dedicated for social interactions and personal relationships.

A social networking service 130 with other applications enables users 110 to communicate with each other by posting information such as comments, messages, photographs, speeches and talks, songs, videos, and etc. . . .

Embodiments of the present disclosure may allow a user 110 to communicate with a server of social networking service 130 to receive an alert if a content sent for upload includes OIP (obscenity, indecency, and profanity) element or elements. Certain embodiments may allow a user 110 to communicate with a server of social networking service 130 to operate a system to automatically and/or manually generate a censored version of the content, in prior to uploading process. For some embodiments, the system may also allow users 110 to alter other kinds of undesired contents such as personal information, personal phone number, license number, etc., in prior to posting on a social network 120. For some other embodiments, the system may also allow users 110 with other alternatives such as to add warning notification when a user 110 choose not to alter the OIP (obscenity, indecency, and profanity) element or elements. Further communication with user 110 and Social Networking service 130 may be followed in this case.

Embodiments of the present disclosure may allow a Social Networking service 130 to comprise of an interface to access digital Database 140 in order to support analytics and training purpose of machine learning and deep learning models.

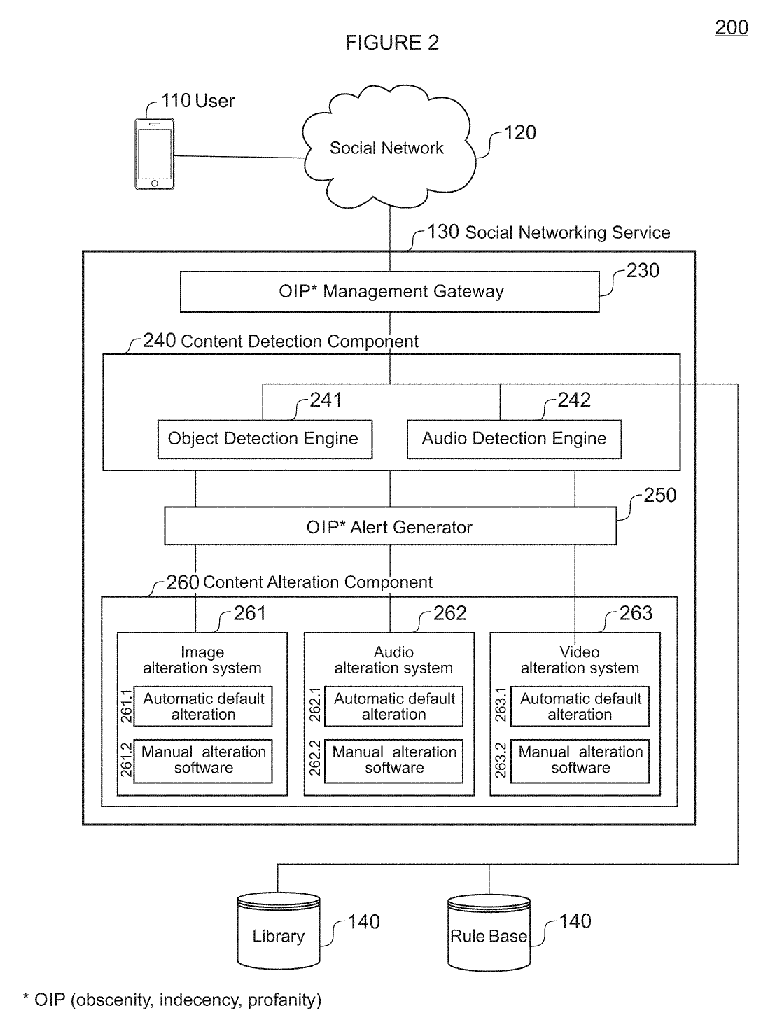

FIG. 2 illustrates an example of structure 200 that enables to operate a system to alter OIP (obscenity, indecency and profanity), in which embodiments of the present disclosure may be employed.

FIG. 2 depicts a Social Network 120 with its service supported by a Social Networking Service 130 that consists of an OIP (obscenity, indecency and profanity) Management Gateway 230, a Content Detection Component 240, an OIP (obscenity, indecency and profanity) Alert Generator 250, and a Content Alteration Component 260. A Content Detection Component 240 may utilize access to digital Database 140 in order to support analytics and training purpose of machine learning and deep learning models.

Essentially, when an OIP (obscenity, indecency and profanity) is detected in a content sent from a user 110 of Social Network 120, system 200 provides a user 110 with three options before the step of user uploading the content: to whether attempt to upload the content with an automatically altered version or, a manually altered version that user manually alters the content or, not to alter the content at all.

Embodiments of the present disclosure may allow an OIP (obscenity, indecency and profanity) Management Gateway 230 to communicate with a user interface of a Social Networking Service 130 and a Content Detection Component 240 to receive content from a user 110 at a Content Detection Component 240.

Embodiments of the present disclosure may allow a Content Detection Component 240 to provide a system to screen and detect an element or elements of OIP (obscenity, indecency and profanity) from a content sent from a user 110 of Social Networking Service 120.

Embodiments of the present disclosure may allow an OIP Management Gateway 230 to communicate with an OIP Alert Generator 250 to receive result of content screening from a Content Detecting Component 240 and send result alert to a user 110 through an interface of Social Networking Service 130.

Embodiments of the present disclosure may allow an OIP Management Gateway 230 to communicate with a Content Alteration Component 260 to allow a user 110 of a Social Networking Service 130 to operate a Content Alteration Component 260 to alter an image or an audio or a video in prior to its uploading process.

Embodiments of the present disclosure, a Content Detection Component 240 may include an Object Detection Engine 241 and an Audio Detection Engine 242.

Embodiments of the present disclosure may allow an Object Detection Engine 241 to provide a system to screen and detect a content including an element or elements of OIP (obscenity, indecency and profanity) in a visual data such as image and video.

Embodiments of the present disclosure may allow an Audio Detection Engine 242 to provide a system to screen and detect a content including an element or elements of OIP (obscenity, indecency and profanity) in an audio data such as sound track and sound track of video.

Embodiments of the present disclosure may allow a Content Detecting Component 240 to communicate with digital Database 140 in order to support analytics and training purpose of machine learning and deep learning models.

Embodiments of the present disclosure, a Content Alteration Component 260 may include an Image alteration system 261, an Audio alteration system 262, and a Video alteration system 263.

Embodiments of the present disclosure, an Image alteration system 261 may include system to support methods for an Automatic default alteration 261.1 of an image, and a Manual alteration software 261.2 of an image.

Embodiments of the present disclosure, an Audio alteration system 262 may include system to support methods for an Automatic default alteration 262.1 of an audio, and a Manual alteration software 262.2 of an audio.

Embodiments of the present disclosure, a Video alteration system 263 may include system to support methods for an Automatic default alteration 263.1 of a video, and a Manual alteration software 263.2 of a video.

Certain embodiments allow a user 110 of a Social Networking Service 130 to operate an Image alteration system 261 through an interface generated by an OIP Management Gateway 230. For some embodiments, a user 110 may choose to alter a content utilizing an Automatic default alteration 261.1. For some other embodiments, a user 110 may choose to alter a content by operating a Manual alteration software 261.2. In some embodiments, a user 110 may choose not to alter content at all. If a user 110 choose not to correct an OIP detected content, further communication may be provided through an OIP Management Gateway 230.

Certain embodiments allow a user 110 of a Social Networking Service 130 to operate an Audio alteration system 262 through an interface generated by an OIP Management Gateway 230. For some embodiments, a user 110 may choose to alter a content utilizing an Automatic default alteration 262.1. For some other embodiments, a user 110 may choose to alter a content by operating a Manual alteration software 262.2. In some embodiments, a user 110 may choose not to alter content at all. If a user 110 choose not to correct an OIP detected content, further communication may be provided through an OIP Management Gateway 230.

Certain embodiments allow a user 110 of a Social Networking Service 130 to operate a Video alteration system 263 through an interface generated by an OIP Management Gateway 230. For some embodiments, a user 110 may choose to alter a content utilizing an Automatic default alteration 263.1. For some other embodiments, a user 110 may choose to alter a content by operating a Manual alteration software 263.2. In some embodiments, a user 110 may choose not to alter a content at all. If a user 110 choose not to correct an OIP detected content, further communication may be provided through an OIP Management Gateway 230.

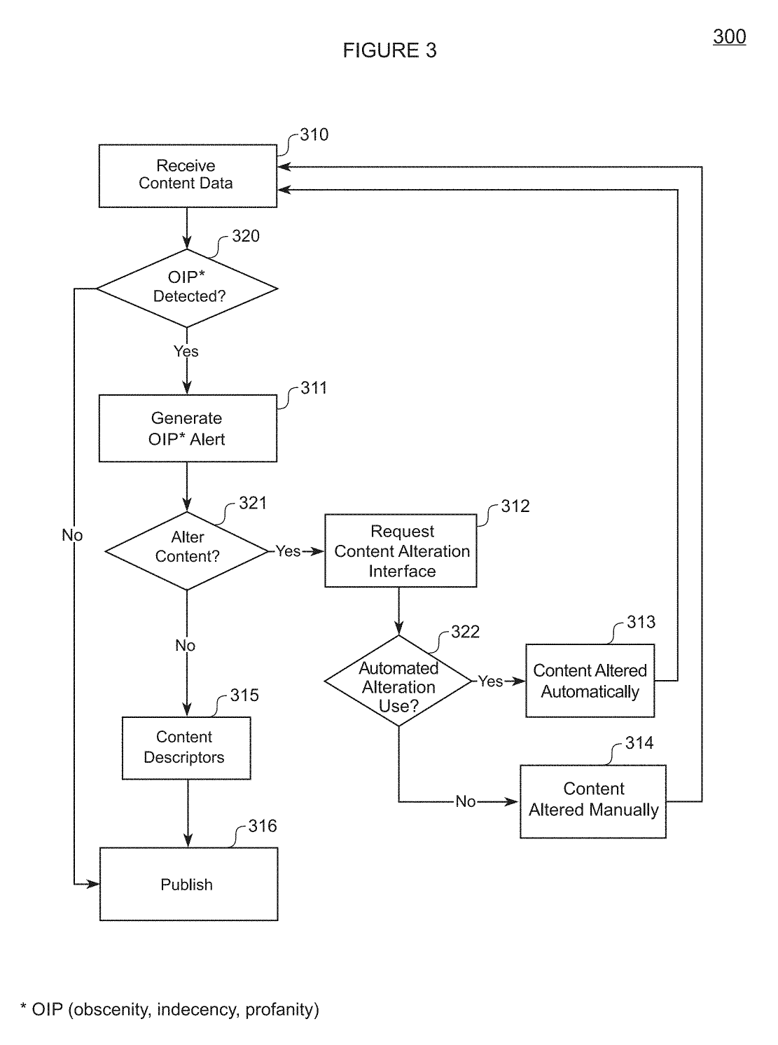

FIG. 3 illustrates an example operations 300 that may be performed, for example, at the OIP Management Gateway 230, for receiving a content at Content Detection Component 240, and if OIP (obscenity, indecency and profanity) element or elements are detected, then transferring a generated OIP alert message between the OIP Alert Generator 250 and a user 110 of a Social Networking Service 130. The operations 300 may also be performed, for example, at the OIP Management Gateway 230, for receiving a request to operate Content Alteration Component 260, and when operation is completed, then transferring a censored content between the Content Alteration Component 260 and a user 110 of a Social Networking Service 130. The operations 300 may also be performed, for example, to allow the OIP Management Gateway 230 to further communicate with a user 110 regarding an OIP (obscenity, indecency and profanity) detected content, if necessary. For example, when I user wish not to alter OIP (obscenity, indecency and profanity) detected content.

Referring to FIG. 3, rectangles 310-316, illustrate steps in the flow. Diamonds 320-322, illustrate decision points in the flow.

The operations 300 begin, at 310 by receiving content data that are sent from a user in the Social Network 120. If an OIP (obscenity, indecency and profanity) is not detected from the Content Detection Component 240, as determined at 320, the IOP Management Gateway 230 is notified that the content has been published, at 316.

If an OIP (obscenity, indecency and profanity) is detected from the Content Detection Component 240, as determined at 320, the OIP Management Gateway 230 is notified that the OIP alert has been generated from the OIP Alert Generator 250, at 311. After step 311 the operation proceed to decision point 321. If an altering content procedure is requested from a user interface of the OIP Management Gateway 230, as determined at 321, the Content Alteration Component 260 is notified that the Content Alteration Interface has been requested, at 312. After step 312 the operation proceed to decision point 322. If an automated alteration is requested from a user interface of the OIP Management Gateway 230, as determined at 322, the Content Alteration Component 260 is notified that the Automatic Alteration of the content has been requested, at 313. After step 313 the operation return back to beginning step, receiving automatically modified content data, at 310.

If an automated alteration is not requested from a user interface of the OIP Management Gateway 230, as determined at 322, the Content Alteration Component 260 is notified that the Manual Alteration of the content has been requested, at 314. After step 314 the operation return back to beginning step, receiving manually altered content data, at 310.

If a user 110 send a request not to alter the content to the OIP Management Gateway 230, as determined at 321, the OIP Management Gateway 230 is notified for further communication with the user, at 315. In some instances (e.g. when the content is not appropriate for certain age group, etc), IOP Management Gateway 230 may suggest a user to insert warnings for viewer discretion. In other instances, IOP Management Gateway 230 may suggest that the content may be removed for a period of time, or in another instances, IOP Management Gateway 230 may send warning to the user that the content may not be uploaded on a Social Network 120. After step 315 the operation proceed to final step of publishing the content, at 316.

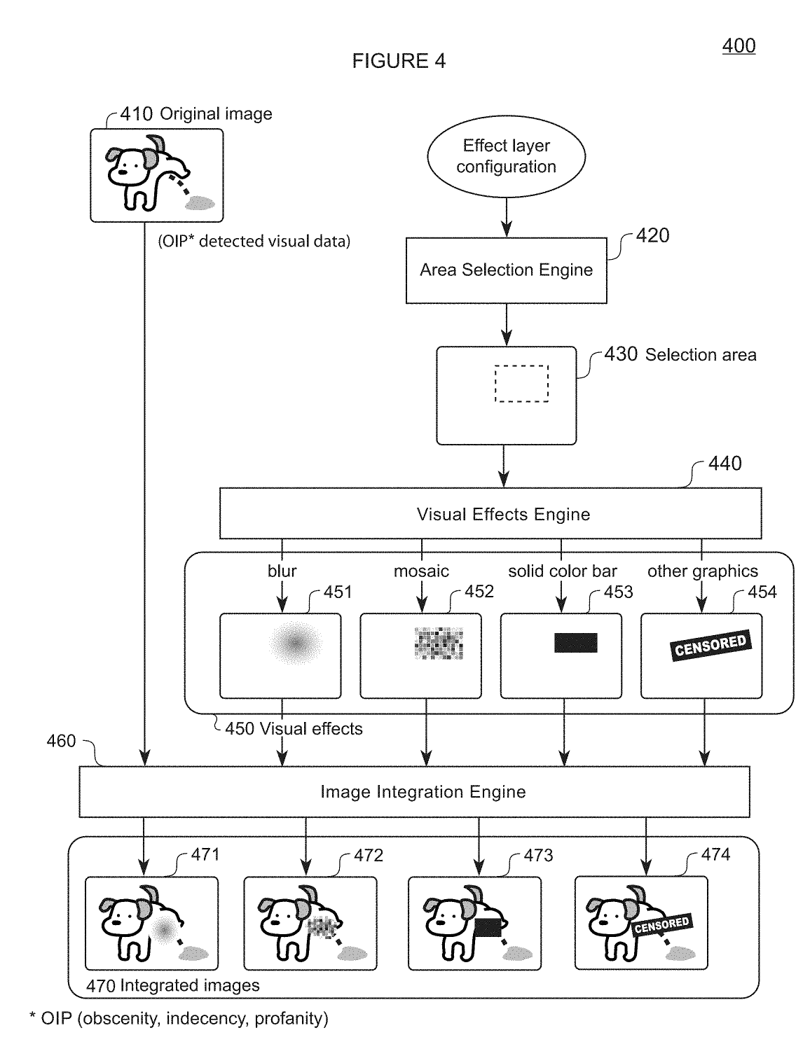

FIG. 4 illustrates an example method for image alteration 400 that may be implemented in an OIP Management Gateway 230 that utilize Image alteration system 261 of a Content Alteration Component 260.

Original image data 410 is shown being provided as input to the Image alteration system 261 of the Content Alteration Component 260. The Image Integration Engine 460 may combine the Original image data 410 with one of created Visual effects 450. Various kinds of altered versions of images may be created, at Integrated images 470.

Effect layer configuration is initiated in conjunction with an Original image 410 being provided as input to the method 400. An operation of the Effect layer configuration begin, by creating an imaginary blank layer to analyze the visual data of Original image 410 and to generate a selection area where a visual effect should take place, at the Area Selection Engine 420.

Once a Selection area 430 is created, a Visual effect is generated, at the Visual Effects Engine 440. Variety of different Visual effects 450 (e.g. blur 451, mosaic 452, solid color bar 453 and other graphics 454 and etc.) may be created.

Once one of Visual effects 450, is created, it is provided as input to the Image Integration Engine 460, to be integrated with the original image 410. Variety of different integrated images 470 (e.g. blur censored image 471, mosaic censored image 472, solid color bar censored image 473 and other graphics censored image 474 and etc.) may be created.

The output of the Image Integration Engine 460 may be sent to an OIP Management Gateway 230 and transferred to a User 110 of a Social Network 120.

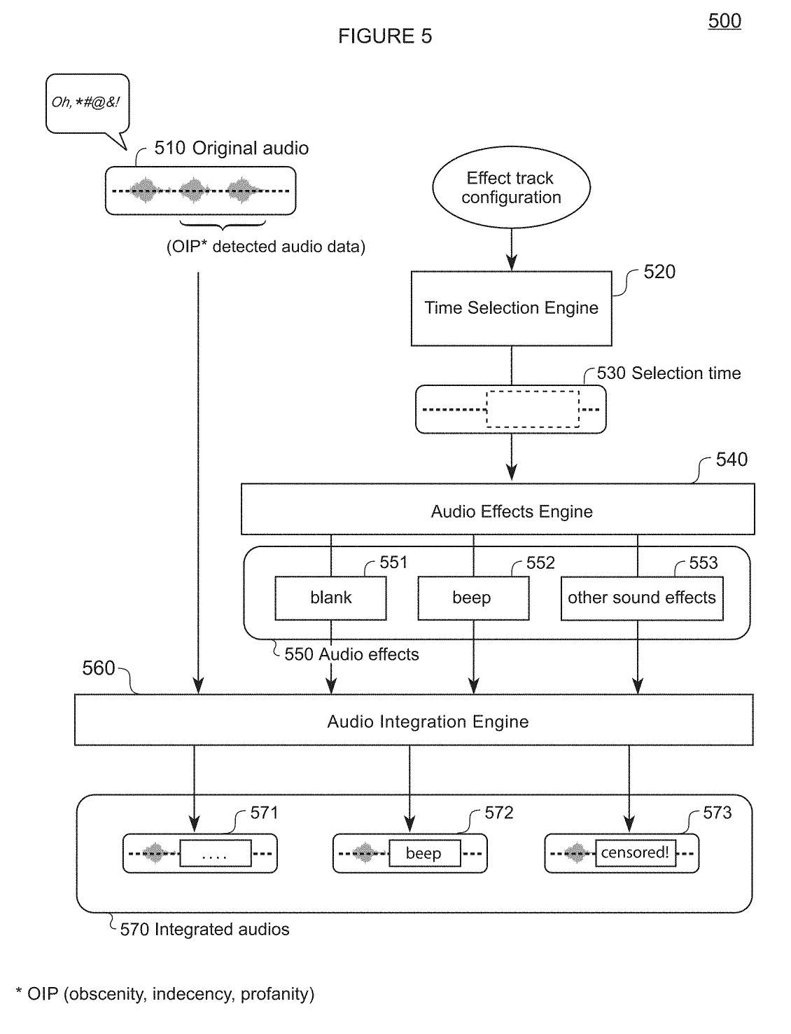

FIG. 5 illustrates an example method for audio alteration 500 that may be implemented in an IOP Management Gateway 230 that utilize Audio alteration system 262 of the Content Alteration Component 260.

Original Audio data 510 is shown being provided as input to the Audio alteration system 262 of the Content Alteration Component 260. The Audio Integration Engine 560 may combine the Original Audio data 510 with one of created Audio effects 550. Various kinds of altered versions of audios may be created, at Integrated audios 570.

Effect track configuration is initiated in conjunction with an Original audio 510 being provided as input to the method 500. An operation of Effect track configuration begin, by creating an imaginary blank sound track to analyze the audio data of original audio 510 and to generate a selection time when an audio effect should take place, at Time Selection Engine 520.

Once a Selection time 530 is created, a sound effect track is generated, at Effects Engine 540. Variety of different sound effects 550 (e.g. blank 551, beep 552, sound effects 553, and etc.) may be created.

Once one of Audio effects 550 is created, it is provided as input to the Audio Integration Engine 560. Portion of original sound on a selection time created at Time Selection Engine 520 may be erased so that it can not be heard. Variety of different Integrated audios 570 (e.g. blank censored audio 571, beep censored audio 572, sound effects censored audio 573, and etc.) may be created.

The output of the Audio Integration Engine 550 may be sent to an OIP Management Gateway 230 and transferred to a User 110 of a Social Network 120.

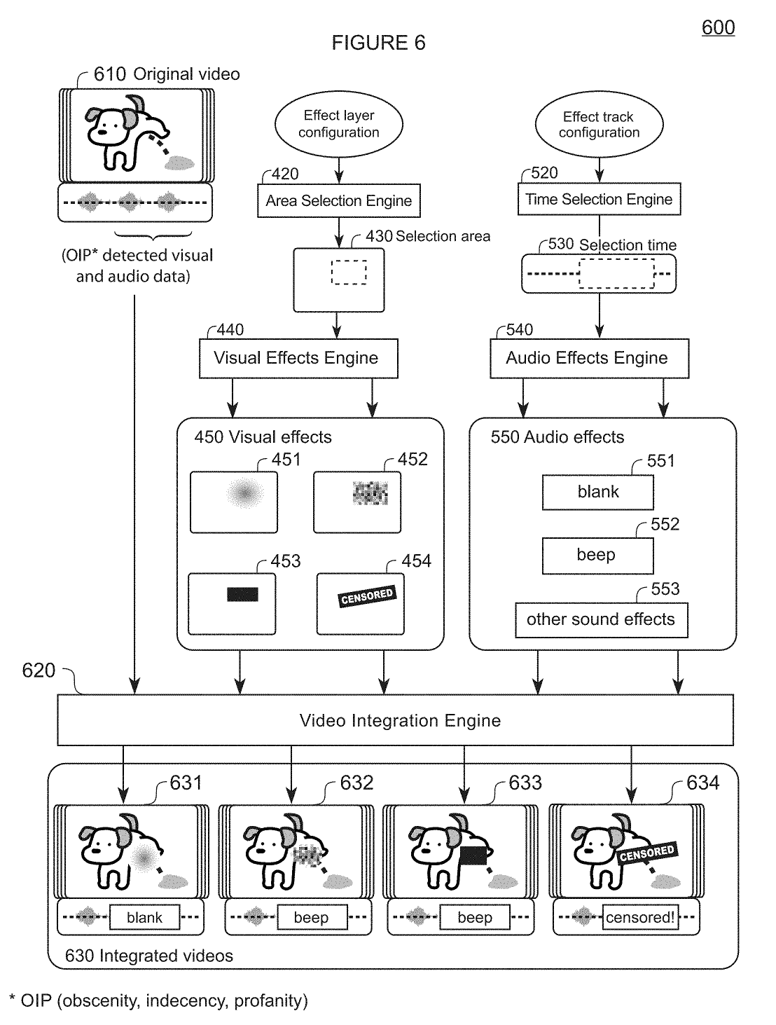

FIG. 6 illustrates an example method for video alteration 600 that may be implemented in an OIP Management Gateway 230 that utilize Video alteration system 263 of the Content Alteration Component 260.

Original video data 610 is shown being provided as input to the Video alteration system 263 of the Content Alteration Component 260. The Video Integration Engine 620 may combine the Original video data 610 with one of created Visual effects 450 and/or Audio effects 550. Various kinds of altered versions of videos may be created, at Integrated videos 630.

Effect layer configuration and Effect track configuration are initiated in conjunction with an Original video 510 being provided as input to the method 600. An operation of Effect layer configuration begin, at Area Selection Engine 420 by creating an imaginary blank layer to analyze the visual data of Original video 610 and to generate a selection area where a visual effect should take place. At the same time, an operation of Effect track configuration begin, by creating an imaginary blank sound track to analyze the audio data of Original video 610 and to generate a selection time when an audio effect should take place, at Time Selection Engine 520.

Once a Selection area 430 and a Selection time 530 are created, for visual effect: one of a Visual effect 450 is generated at the Visual Effects Engine 440 and; for audio effect, one of an Audio effect 550 is generated at the Audio Effects Engine 540. Variety of different effect layers (e.g. blur 641, mosaic 642, solid color bar 643 and other graphics 644 and etc.) and variety of different sound effects 550 (e.g. blank 551, beep 552, sound effects 553, and etc.) may be created.

Once one of a Visual effect 450 and/or Audio effect 550 are created, they are sent as input to the Video Integration Engine 620. Variety of different combinations of integrated videos 630 (e.g. blur with blank sound censored video 631, mosaic with beep censored video 632, solid color bar with beep censored video 633 and other graphics with other sound effects censored video 634 and etc.) may be created.

The output of the Video Integration Engine 620 may be sent to an OIP Management Gateway 230 and transferred to a User 110 of a Social Network 120.

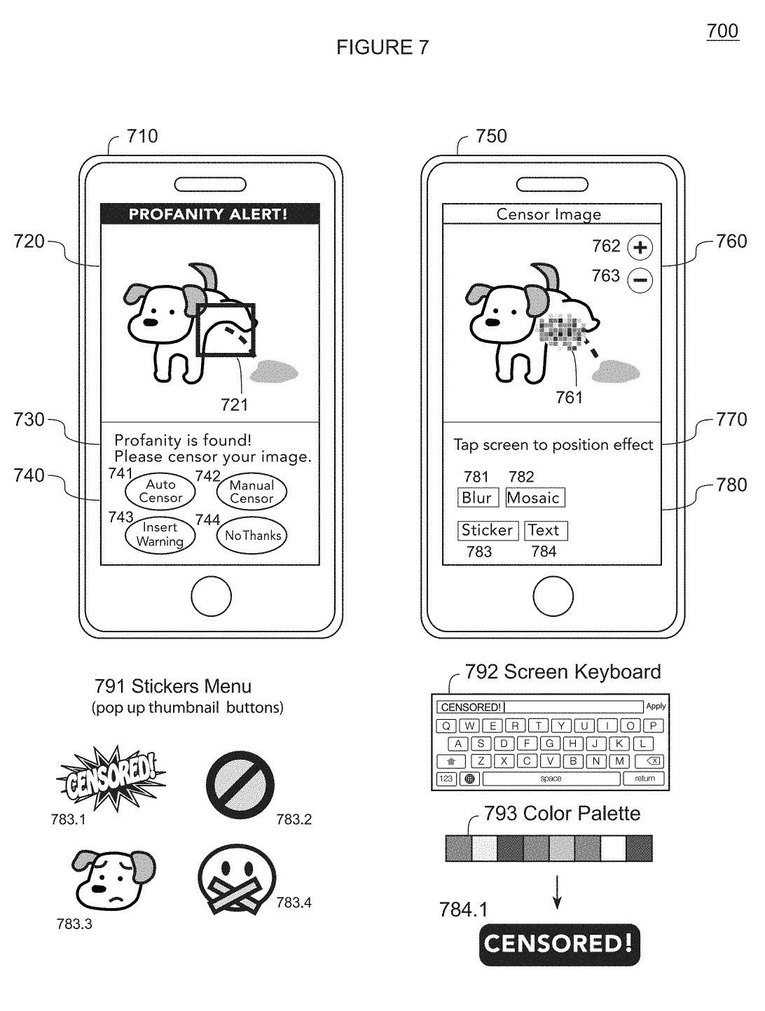

FIG. 7 illustrates an example of screen interface 700 that a user 110 may use to receive an alert message from OIP Alert Generator 250 and, to operate an Image Alteration System 261 of Content Alteration Component 260, in which embodiments of the present disclosure may be employed.

A screen 710 is an example interface a user may view to receive an alert of OIP (obscenity, indecency and profanity) being detected from an image that has been sent to Social Networking Service 130, in order to upload it on a Social Network 120. A message from OIP Alert Generator 250; [PROFANITY ALERT!] is being displayed in this example.

Certain embodiments allow an Image Display Window 720 to import and display an image that has been alerted for obscenity, indecency and profanity element or elements. A Selection area 721 is generated from Area Selection Engine 420 is displayed, as shown by the highlighted box. The user 110 of Social Networking Service 130 may then identify what object or objects in which portions of the image should be altered.

In some embodiments, further messages from OIP Management Gateway 230 are displayed in Text area 730.

Buttons to initiate the next step is listed, for certain embodiments, in Button area 740. User may choose one of the options listed. A user 110 who wish to use an automated alteration procedure may choose to tap on Auto Censor Button 741. A user 110 who wish to operate the alteration software and censor content manually may choose to tap on Manual Censor Button 742. A user 110 who wish to user an alternative method such as inserting warning messages may choose to tap on Insert Warning Button 743. A user 110 who do not wish to alter image may choose to tap on No thanks Button 744.

A screen 750 is an example interface of a Manual Alteration Software 261.2 of Image Alteration System 261. A user may operate the software provided by OIP Management Gateway 230 to alert OIP (obscenity, indecency and profanity) element or elements in this screen. A title of operation [Censor Image] is being displayed in this example.

For certain embodiments, the Work Space 760 imports and displays an image that has been alerted for obscenity, indecency and profanity element or elements. Also a default version of a Visual Effect 761 generated from Automatic Default Alteration 261.1 is displayed. An operator may then tap on the Visual Effect 761 to move and reposition the Visual Effect 761 in the Work Space 760. A Work Space 760 may also include Scaling button (+) 762 to enlarge the Visual Effect 761 in order to cover more area of the original image, and Scaling button (−) 763 to shrink the Visual Effect 761 in order to cover less area of the original image.

In some embodiments, further messages from OIP Management Gateway 230 are displayed in Text area 770.

Certain embodiments provide button links to initiate the modification step. Different buttons are listed in Button area 780. An operator may then modify the effect to create her/his own style by choosing one of the options listed. An operator who wishes to use blur may choose to tap on blur Button 781. An operator who wishes to use mosaic may choose to tap on Mosaic Button 782. An operator who wishes to use a sticker to cover up the area, choose to tap on Sticker Button 783. Thumb nails of stickers (783.1, 783.2, 783.3, 783.4) may apper on pop up Stickers Menu 791, which may be utilized for an operator to choose the desired sticker. An operator who wishes to create graphic with original text, may choose to tap on text Button 784.

For certain embodiments, Screen Keyboard 792 may be initiated when an operator choose to create original Texted graphic 784.1 by tapping Text Button 784. A pop up color palette 793 may be utilized for an operator to choose the desired background color.

After modifying Visual Effect 761, an operator may return to Work Space 760 to move and resize the new, modified Visual Effect 761 to properly alter the image.

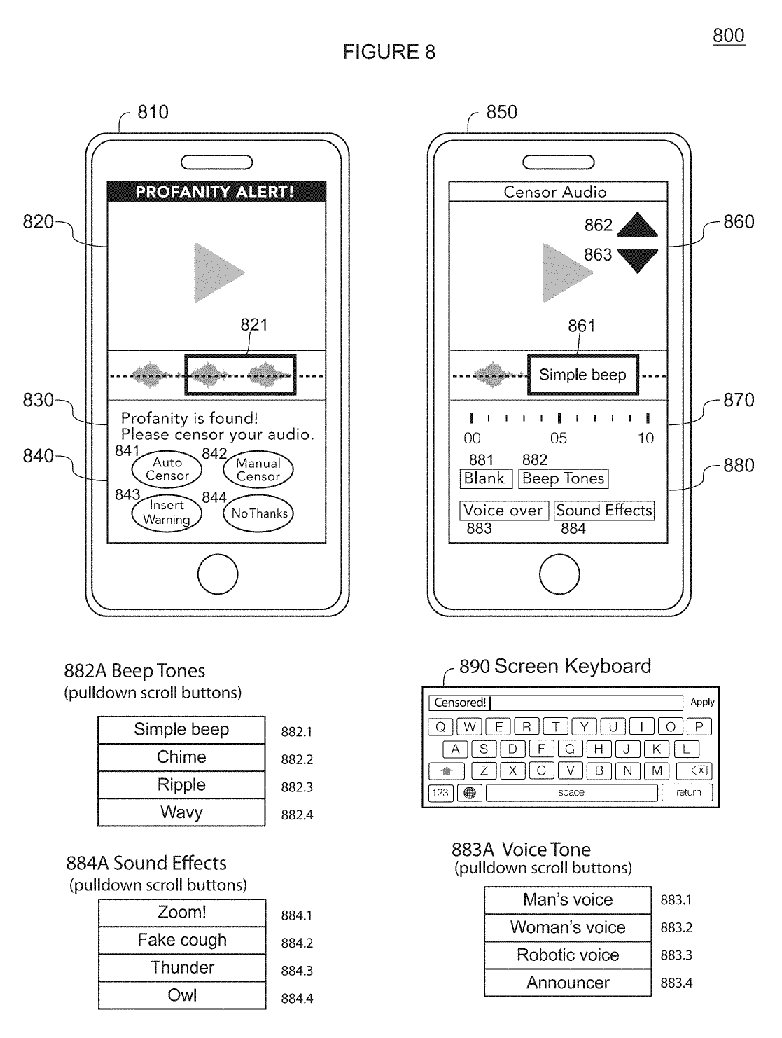

FIG. 8 illustrates an example of screen interface 800 that a user 110 may use to receive an alert message from OIP Alert Generator 250 and, to operate an Audio Alteration System 262 of Content Alteration Component 260, in which embodiments of the present disclosure may be employed.

A screen 810 is an example interface a user may view to receive an alert of OIP (obscenity, indecency and profanity) being detected from an audio that has been sent to Social Networking Service 130, in order to upload it on a Social Network 120. A message from OIP Alert Generator 250; [PROFANITY ALERT!] is being displayed in this example.

Certain embodiments allow an Audio Display Window 820 to import and display an audio track that has been alerted for obscenity, indecency and profanity element or elements. A Selection time 821 is generated from Time Selection Engine 520 is displayed, as shown by the highlighted box. The user 110 of Social Networking Service 130 may then identify when in what time frame of the sound track the audio should be altered.

In some embodiments, further messages from OIP Management Gateway 230 are displayed in Text area 830.

Buttons to initiate the next step is listed, for certain embodiments, in Button area 840. User may choose one of the options listed. A user 110 who wish to use an automated alteration procedure may choose to tap on Auto Censor Button 841. A user 110 who wish to operate the alteration software and censor manually may choose to tap on Manual Censor Button 842. A user 110 who wish to user an alternative method such as inserting warning messages may choose to tap on Insert Warning Button 843. A user 110 who do not wish to alter audio may choose to tap on No thanks Button 844.

A screen 850 is an example interface of a Manual Alteration Software 262.2 of Audio Alteration System 262. A user may operate the software provided by OIP Management Gateway 230 to alert OIP (obscenity, indecency and profanity) element or elements in this screen. A title of operation [Censor Audio] is being displayed in this example.

For certain embodiments, the Work Space 860 imports and displays an audio track that has been alerted for obscenity, indecency and profanity element or elements. Also a default version of an Audio Effect 861 generated from Automatic Default Alteration 261.1 is displayed.

Additionally, the sound within the time frame of the selection time may be deleted. A Work Space 860 may also include Volume Scaling Button (↑) 862 to increase the volume of the Audio Effect 761, and Volume Scaling button (↓) 863 to decrease the volume of the Audio Effect 761, depending on the user preferences.

For certain embodiments, a time line is displayed in Timeline area 870 in order to move the Audio Effect 861 within the timeline, for example, when an Audio Effect is long and an operator prefer to start audio effect at an earlier timing.

Buttons to initiate the modification step is listed, for certain embodiments, in Button area 880. An operator may then modify the effect to create her/his own style by choosing one of the options listed. An operator who wishes to use blank may choose to tap on blank Button 881. An operator who wishes to use beep tones may choose to tap on select beep tones Button 882. A pop up scroll down buttons 882A will provide a list of beep tone choices such as Simple beep 882.1, Chime 882.2, Ripple 882.3, Wavy 882.4 and etc. . . . An operator who wishes to create voice over with original text, may choose to tap on Voice over Button 883. An operator who wishes to use other sound effects may choose to tap on select Sound effects Button 884. A pop up scroll down buttons 884A will provide a list of sound effect choices such as Zoom! 884.1, Fake cough 884.2, Thunder! 884.3, Owl 884.4 and etc. . . .

For certain embodiments, a Screen Keyboard 890 is initiated when an operator choose to create original graphic by tapping Text Button 883. A pop up scroll buttons 883A will provide a list of voice over choices such as Man's voice 883.1, Woman's voice 883.2, Robotic voice 883.3, Announcer 883.4 and etc. . . . Voices of voice over may be automatically generated by utilizing a text to speech software.

After modifying Effect 761, an operator may return to Timeline area 870 to move and modify length of Audio Effect 861 to properly alter the audio.

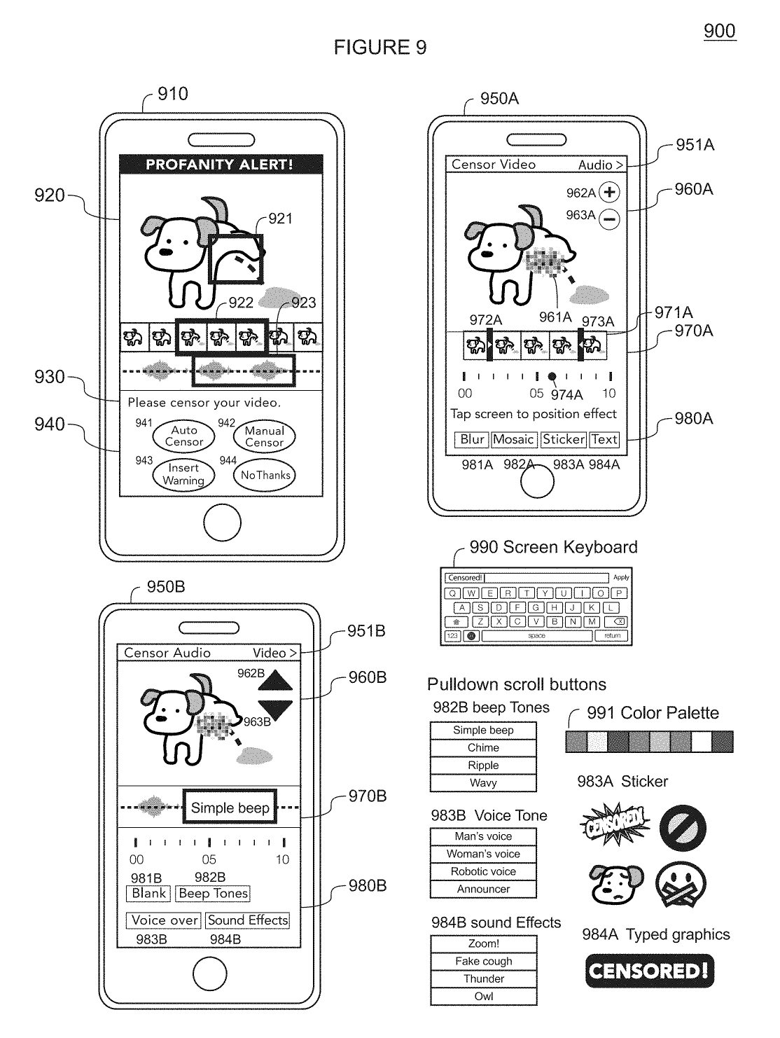

FIG. 9 illustrates an example of screen interface 900 that a user 110 may use to receive an alert message from OIP Alert Generator 250 and, to operate a Video Alteration System 263 of Content Alteration Component 260, in which embodiments of the present disclosure may be employed.

A screen 910 is an example interface a user may view to receive an alert of OIP (obscenity, indecency and profanity) being detected from a video that has been sent to Social Networking Service 130, in order to upload it on a Social Network 120. A message from OIP Alert Generator 250; [PROFANITY ALERT!] is being displayed in this example.

Certain embodiments allow an Image Display Window 820 to import and display an audio track that has been alerted for obscenity, indecency and profanity element or elements. A Selection time 821 is generated from Time Selection Engine 520 is displayed, as shown by the highlighted box. The user 110 of Social Networking Service 130 may then identify when in what time frame of the sound track the audio should be altered.

In some embodiments, further messages from OIP Management Gateway 230 are displayed in Text area 930.

Buttons to initiate the next step is listed, for certain embodiments, in Button area 940. User may choose one of the options listed. A user 110 who wish to use an automated alteration procedure may choose to tap on Auto Censor Button 941. A user 110 who wish to operate the alteration software and censor manually may choose to tap on Manual Censor Button 942. A user 110 who wish to user an alternative method such as inserting warning messages may choose to tap on Insert Warning Button 943. A user 110 who do not wish to alter audio may choose to tap on No thanks Button 944.

A screen 950A and 950B are example interfaces of a Manual Alteration Software 263.2 of Video Alteration System 263. A user may operate the software provided by OIP Management Gateway 230 to alert OIP (obscenity, indecency and profanity) element or elements on these screens. On a title bar 951A, a title of operation [Censor Video] along with link to Audio Censoring software [Audio >] is being displayed. On a title bar 951B, a title of operation [Censor Audio] along with link to Video Censoring software [Video >] is being displayed. An operator of this software may switch back and forth between audio editing work space and visual editing work space by tapping these links.

For certain embodiments, in a visual editing system, a Work Space 960A imports and displays a visual data of video that has been alerted for obscenity, indecency and profanity element or elements. Also a default version of a Visual Effect 961A generated from Automatic Default Alteration 261.1 is displayed. An operator then may tap on the Visual Effect 961A to move and reposition the Visual Effect 961A on the Work Space. The Work Space 960A may also include Scaling button (+) 962A to enlarge the Visual Effect 961A in order to cover more area of the original video, and Scaling button (−) 963A to shrink the Visual Effect 961A in order to cover less area of the original video.

Certain embodiments provide a Video track 970A that may include an image sequence 971A, and a Timeline 972A. An image sequence 971A may allow an operator to select the In point 973A, where the Visual Effect 961A may start appearing and Out point 974A, where Visual Effect 961A may cut out. A Timeline 972A may allow an operator to tap to create a key frame, for example a key frame at time :06 974A in order to animate the position of Visual Effect 961A in a screen. Further messages from OIP Management Gateway 230 are displayed below the video track.

Certain embodiments provide button links to initiate the modification step. Different buttons are listed in Button area 980A. An operator then may modify the effect to create her/his own style by choosing one of the options listed. An operator who wishes to use blur may choose to tap on Blur Button 981A.
An operator who wishes to use mosaic may choose to tap on mosaic Button 982A. An operator who wishes to use stickers may choose to tap on Sticker Button 983A. A pop up Thumbnails of stickers 993A may be utilized to choose the desired sticker. An operator who wishes to create graphic with original text, may choose to tap on Text Button 984A.

Screen Keyboard 990 is initiated when an operator choose to create original graphic by tapping Text Button 984A. A pop up color palette 991 may be utilized to choose the desired background color.

After modifying Visual Effect 961A, an operator may return to Work Space 960A to move and resize the new, modified Visual Effect 961A to properly alter the video. end

For certain embodiments, in an audio editing system, A Work Space 960B imports and displays an audio track that has been alerted for obscenity, indecency and profanity element or elements. Also a default version of an Audio Effect 961B generated from Automatic Default Alteration 261.1 is displayed. Additionally, the sound within the time frame of the selection time may be deleted. A Work Space 960B may also include Volume Scaling Button (↑) 962B to increase the volume of the Audio Effect 961B, and Volume Scaling button (↓) 963B to decrease the volume of the Audio Effect 961B, depending on the user preferences.

A Timeline 970B is provided in order to move the Audio Effect 961B within the timeline, for example, when an Audio Effect is long and a user prefer to start audio effect in earlier timing.

Buttons to initiate the modification step is listed, for certain embodiments, in Button area 980B. The operator may then modify the effect to create her/his own style by choosing one of the options listed. An operator who wishes to use blank may choose to tap on Blank Button 981B. An operator wishes to use beep tones may choose to tap on select Beep tones Button 982B. A pop up Scroll down buttons 982B will provide a list of beep tone choices, for example, such as Simple beep, Chime, Ripple, Wavy and etc. . . . An operator who wishes to create voice over with original text, may choose to tap on voice over Button 983B. An operator who wishes to use other Sound effects may choose to tap on select sound effects Button 984B. A pop up scroll down buttons 984B will provide a list of sound effect with choices, for example, such as Zoom!, Fake cough, Thunder!, Explosion! and etc. . . .

For certain embodiments, a Screen Keyboard 990 is initiated when an operator choose to create original graphic by tapping Text Button 983B. A pop up scroll buttons 983B will provide a list of voice over choices, for example, such as Man's voice, Woman's voice, Robotic voice, Announcer and etc. . . . Voices of voice over may be automatically generated by text to speech software.

After modifying Effect 961B, an operator may return to Timeline area 970B to move and modify length of Audio Effect 961B to properly alter the audio.

1. System and methods that allow a users of social network to automatically and/or manually alter an image including obscenity or indecency or profanity in prior to its uploading procedure to a social network, comprising:
a software that enabling; in response to automatic detection and automatic alteration of an image including obscenity, indecency or profanity, a social network user to create an original versions of alteration by modifying a default version created by an automatic system.

2. The method of claim 1, wherein enabling a user to modify a default visual alteration by replacing it with another visual effect by operating a manually alteration software.

3. The method of claim 1, wherein enabling a user to modify a default visual alteration by replacing it with another graphics created by a user by operating a manually alteration software.

4. The method of claim 1, wherein enabling a user to type text over a generated alteration such as but not limited to color bar and etc, by operating a manually alteration software.

5. The method of claim 1, wherein enabling a user to apply a graphic sticker from a library to cover undesired area of an image.

6. The method of claim 1, wherein enabling a user to modify a generated visual effect by resizing and repositioning on an image.

7. System and methods that allow a social network user to automatically and/or manually alter an audio of obscene, indecent or profane content, in prior to uploading it on a social network, comprising:
a software that enabling; in response to detecting and automatic alteration of an audio including obscenity, indecency or profanity, a social network user to create an original versions of alteration by modifying a default version created by an automatic system.

8. The method of claim 7, wherein enabling a user to modify a default audio alteration by replacing it with another audio effect by operating a manually alteration software.

9. The method of claim 7, wherein enabling a user to modify a default audio alteration by replacing it with another sound effect by operating a manually alteration software.

10. The method of claim 7, wherein enabling a user to modify a default audio alteration by replacing it with a vocal language generated by text to voice software.

11. The method of claim 7, wherein enabling a user to reposition audio effects' in and out point on a timeline of sound track, and stretching and shrinking audio effects on a timeline of sound track.

12. System and methods that allow a social network user to automatically and/or manually alter a video of obscene, indecent or profane content, in prior to uploading it on a social network, comprising:
a software that enabling; in response to detecting and automatic alteration of an audio including obscenity, indecency or profanity, a social network user to create an original versions of alteration by modifying a default version created by an automatic system.

13. The method of claim 12, wherein enabling a user to modify a default visual alteration by replacing it with another visual effect by operating a manually alteration software.

14. The method of claim 12, wherein enabling a user to modify a default visual alteration by replacing it with another graphics created by a user by operating a manually alteration software.

15. The method of claim 12, wherein enabling a user to type text over a generated alteration such as but not limited to color bar and etc, by operating a manually alteration software.

16. The method of claim 12, wherein enabling a user to apply a graphic sticker from a library to cover undesired area of video screen.

17. The method of claim 12, wherein enabling a user to modify a default audio alteration by replacing it with another audio effect by operating a manually alteration software on a sound track of a video.

18. The method of claim 12, wherein enabling a user to modify a default audio alteration by replacing it with another sound effect by operating a manually alteration software on a sound track of a video.

19. The method of claim 12, wherein enabling a user to modify a default audio alteration by replacing it with a vocal language generated by text to voice software on a sound track of a video.

20. The method of claim 12, wherein enabling a user to modify a generated visual and/or audio effects by;
for visual effects, resizing and repositioning on screens of sequence of images and to reposition visual effect's in and out point on a timeline of video track of a video, and for audio effects, reposition audio effects' in and out point on a timeline of sound track of a video, and stretching and shrinking audio effects on a timeline of sound track of a video.
